(19) United States
(12) Patent Application Publication
(10) Pub. No.: US 2010/0015467 A1
(43) Pub. Date: Jan. 21, 2010

(54) METHOD FOR COATING A SUBSTRATE AND COATED PRODUCT

(75) Inventors: Stefan Zimmermann, Laufenburg (DE); Steven A. Miller, Canton, MA (US); Leonid N. Shekter, Ashland, MA (US)

Correspondence Address: CONNOLLY BOVE LODGE & HUTZ, LLP, P O BOX 2207, WILMINGTON, DE, 19899, US

(73) Assignee: H.C. Starck GmbH & Co., KG, Goslar (DE)

(21) Appl. No.: 12/513,715

(22) PCT Filed: Oct. 12, 2007
(86) PCT No.: PCT/US07/81200

§ 371 Date: Jul. 30, 2009

Related U.S. Application Data
(60) Provisional application No. 60/864,729, filed on Nov. 7, 2006.

(51) Int. Cl. B32B 15/04; B05D 1/12; B32B 15/08; B32B 15/01; B32B 18/00; C22C 27/02; C22C 19/03

(52) U.S. Cl. 428/615; 427/185; 428/469; 428/457; 420/425; 420/427; 420/441

(57) ABSTRACT

Disclosed is a method of applying coatings to surfaces, wherein a gas flow forms a gas-powder mixture with a powder of a material selected from the group consisting of niobium, tantalum, tungsten, molybdenum, titanium, zirconium, nickel, cobalt, iron, chromium, aluminum, silver, copper, mixtures of at least two thereof or their alloys with at least two thereof or with other metals, the powder has a particle size of from 0.5 to 150 μm, an oxygen content of less than 500 ppm oxygen and a hydrogen content of less than 500 ppm, wherein a supersonic speed is imparted to the gas flow and the jet of supersonic speed is directed onto the surface of an object. The coatings prepared are used, for example, as corrosion protection coatings.

The present invention relates to a method of applying coatings which contain only small amounts of different gaseous impurities, in particular oxygen and hydrogen.

The application of metal coatings, especially of refractory metal coatings to surfaces exhibits numerous problems.

In conventional processes, the metal is completely or partially melted in most cases, as a result of which the metals readily oxidise or absorb other gaseous impurities. For this reason, conventional processes such as deposition-welding and plasma spraying must be carried out under a protecting gas or in vacuo.

In such cases, the outlay in terms of apparatus is high, the size of the components is limited, and the content of gaseous impurities is still unsatisfactory.

The pronounced introduction of heat transmitted into the object to be coated leads to a very high potential for distortion and means that these processes cannot be employed in the case of complex components, which often also contain constituents that melt at low temperatures.

Complex components must therefore be taken apart before they are re-processed, with the result, in general, that re-processing is scarcely economical and only recycling of the material of the components (scrapping) is carried out.

Moreover, in the case of vacuum plasma spraying, tungsten and copper impurities, which originate from the electrodes used, are introduced into the coating, which is generally undesirable. In the case of, for example, the use of tantalum or niobium coatings for corrosion protection, such impurities reduce the protective effect of the coating by the formation of so-called micro-galvanic cells.

Moreover, such processes are processes of melt metallurgy, which always involve the inherent disadvantages thereof, such as, for example, unidirectional grain growth. This occurs in particular in laser processes, where a suitable powder is applied to the surface and melted by means of a laser beam. A further problem is the porosity, which can be observed in particular when a metal powder is first applied and is subsequently melted by means of a heat source. Attempts have been made in WO 02/064287 to solve these problems by merely melting on the powder particles by means of an energy beam, such as, for example, laser beams, and sintering them. However, the results are not always satisfactory and a high outlay in terms of apparatus is required, and the problems associated with the introduction of a reduced but nevertheless high amount of energy into a complex component remain.

WO-A-03/106,051 discloses a method and an apparatus for low pressure cold spraying. In this process a coating of powder particles is sprayed in a gas substantially at ambient temperatures onto a workpiece. The process is conducted in a low ambient pressure environment which is less than atmospheric pressure to accelerate the sprayed powder particles, With this process a coating of a powder is formed on a workpiece.

EP-A-1,382,720 discloses another method and apparatus for low pressure cold spraying. In this process the target to be coated and the cold spray gun are located within a vacuum chamber at pressures below 80 kPa. With this process a workpiece is coated with a powder.

In view of this prior art it was therefore the object, to provide a novel process for coating substrates which is distinguished by the introduction of a small amount of energy, a low outlay in terms of apparatus and broad applicability for different carrier materials and coating materials, and wherein the metal to be applied is not melted on during processing.

Another object of this invention was the provision of a novel process for preparing dense and corrosion resistant coatings, especially tantalum coatings, which possess low content of impurities, preferably low content of oxygen, hydrogen and nitrogen impurities, which coatings are highly qualified for use as corrosion protective layer, especially in equipment of chemical plants.

The object of the present invention is achieved by applying a desired refractory metal to the desired surface by a method as claimed in claim 1.

There are generally suitable for this purpose processes in which, in contrast to the conventional processes of thermal spraying (flame, plasma, high-velocity is flame, arc, vacuum plasma, low-pressure plasma spraying) and of deposition-welding, there is no melting on of the coating material, caused by thermal energy produced in the coating apparatus. Contact with a flame or hot combustion gases is to be avoided, because these can cause oxidation of the powder particles and hence the oxygen content in the resulting coatings rises.

These processes are known to the person skilled in the art as, for example, cold gas spraying, cold spray processes, cold gas dynamic spraying, kinetic spraying and are described, for example, in EP-A-484533. Also suitable according to the invention is the process described in patent DE-A-10253794.

The so-called cold spray process or the kinetic spray process are particularly suitable for the method according to the invention; the cold spray process, which is described in EP-A484533, is especially suitable, and this specification is incorporated herein by reference.

Accordingly, there is advantageously employed a method for applying coatings to surfaces, wherein a gas flow forms a gas-powder mixture with a powder of a material selected from the group consisting of niobium, tantalum, tungsten, molybdenum, titanium, zirconium, nickel, cobalt, iron, chromium, aluminium, silver, copper, mixtures of at least two thereof or their alloys with one another or with other metals, the powder has a particle size of from 0.5 to 150 μm, an oxygen content of less than 500 ppm oxygen and a hydrogen content of less than 500 ppm, wherein a supersonic speed is imparted to the gas flow and a jet of supersonic speed is formed, which ensures a speed of the powder in the gas-powder mixture of from 300 to 2000 m/s, preferably from 300 to 1200 m/s, and the jet is directed onto the surface of an object.

The metal powder particles striking the surface of the object form a coating, the particles being deformed very considerably.

The powder particles are advantageously present in the jet in an amount that ensures a flow rate density of the particles of from 0.01 to 200 g/s cm², preferably 0.01 to 100 g/s cm², very preferably 0.01 g/s cm² to 20 g/s cm², or most preferred from 0.05 g/s cm² to 17 g/s cm².

The flow rate density is calculated according to the formula F=m/(π/4*D²) where F=flow rate density, D=nozzle cross-section, m=powder feed rate. A powder feed rate of, for example, 70 g/min=1.1667 g/s is a typical example of a powder feed rate.

At low D values of below 2 mm values of markedly greater than 20 g/s cm² can be achieved. In this case F can easily assume values 50 g/s cm² or even higher at higher powder delivery rates.

As the gas with which the metal powder forms a gas-powder mixture there is generally used an inert gas such as argon, neon, helium, nitrogen or mixtures of two or more thereof. In particular cases, air may also be used. If safety regulations are met also use of hydrogen or mixtures of hydrogen with other gases can be used.

In a preferred version of the process the spraying comprises the steps of:
providing a spraying orifice adjacent a surface to be coated by spraying;
providing to the spraying orifice a powder of a particulate material chosen from the group consisting of niobium, tantalum, tungsten, molybdenum, titanium, zirconium, nickel, cobalt, iron, chromium, aluminium, silver, copper, mixtures of at least two thereof or alloys thereof with one another or other metals, the powder having a particle size of 0.5 to 150 μm, an oxygen content of less than 500 ppm oxygen and a hydrogen content of less than 500 ppm, said powder being under pressure;
providing an inert gas under pressure to the spraying orifice to establish a static pressure at the spraying orifice and providing a spray of said particulate material and gas onto the surface to be coated; and
locating the spraying orifice in a region of low ambient pressure which is less than 1 atmosphere and which is substantially less than the static pressure at the spraying orifice to provide substantial acceleration of the spray of said particulate material and gas onto said surface to be coated.

In another preferred version of the process the spraying is performed with a cold spray gun and the target to be coated and the cold spray gun are located within a vacuum chamber at pressures below 80 kPa, preferably between 0.1 and 50 kPa, and most preferred between 2 and 10 kPa.

Further advantageous embodiments can be found in the claims.

In general, the metal has a purity of 99% or more, such as 99.5% or 99.7% or 99.9%.

According to the invention, the metal advantageously has a purity of at least 99.95%, based on metallic impurities, especially of at least 99.995% or of at least 99.999%, in particular of at least 99.9995%.

If an alloy is used instead of a single metal, then at least the metal, but preferably the alloy as a whole, has that purity, so that a corresponding highly pure coating can be produced.

In addition, the metal powder has a content of less than 500 ppm oxygen, or less than 300 ppm, in particular an oxygen content of less than 100 ppm, and a content of less than 500 ppm hydrogen, or a hydrogen content of less than 300 ppm, in particular a hydrogen content of less than 100 ppm.

Surprisingly it has been found that, if the amount of these impurities in the starting powders is very low, then the deposition efficiency of the powders increases and the density of the applied coatings is increased.

Particularly suitable refractory metal powders have a purity of at least 99.7%, advantageously of at least 99.9%, in particular 99.95%, a content of less than 500 ppm oxygen, or less than 300 ppm oxygen, in particular an oxygen content of less than 100 ppm and a content of less than 500 ppm hydrogen, or less than 300 ppm hydrogen, in particular a hydrogen content of less than 100 ppm.

Particularly suitable refractory metal powders have a purity of at least 99.95%, in particular of at least 99.995%, and a content of less than 500 ppm oxygen, or less than 300 ppm oxygen, in particular an oxygen content of less than 100 ppm and a content of less than 500 ppm hydrogen, or less than 300 ppm hydrogen, in particular a hydrogen content of less than 100 ppm.

Particularly suitable metal powders have a purity of at least 99.999%, in particular of at least 99.9995%, and a content of less than 500 ppm oxygen, or less than 300 ppm oxygen, in particular an oxygen content of less than 100 ppm and a content of less than 500 ppm hydrogen, or less than 300 ppm hydrogen, in particular a hydrogen content of less than 100 ppm.

In all the above-mentioned powders, the total content of other non-metallic impurities, such as carbon, nitrogen or hydrogen, should advantageously be less than 500 ppm, preferably less than 150 ppm.

In particular, the oxygen content is advantageously 50 ppm or less, the hydrogen content is 50 ppm or less, the nitrogen content is 25 ppm or less and the carbon content is 25 ppm or less.

The content of metallic impurities is advantageously 500 ppm or less, preferably 100 ppm or less and most preferably 50 ppm or less, in particular 10 ppm or less.

Preferred suitable metal powders are, for example, many of the refractory metal powders which are also suitable for the production of capacitors.

Such metal powders can be prepared by reduction of refractory metal compound with a reducing agent and preferably subsequent deoxidation.

Tungsten oxide or molybdenum oxide, for example, is reduced in a stream of hydrogen at elevated temperature. The preparation is described, for example, in Schubert, Lassner, “Tungsten”, Kluwer Academic/Plenum Publishers, New York, 1999 or Brauer, “Handbuch der Präparativen Anorganischen Chemie”, Ferdinand Enke Verlag Stuttgart, 1981, p 1530.

In the case of tantalum and niobium, the preparation is in most cases carried out by reducing alkali heptafluorotantalates and earth alkaline metal heptafluoro-tantalates or the oxides, such as, for example, sodium heptafluorotantalate, potassium heptafluorotantalate, sodium heptafluoroniobate or potassium heptafluoroniobate, with an alkali or alkaline earth metal. The reduction can be carried out in a salt melt with the addition of, for example, sodium, or in the gas phase, calcium or magnesium vapour advantageously being used. It is also possible to mix the refractory metal compound with the alkali or alkaline earth metal and heat the mixture. A hydrogen atmosphere may be advantageous. A large number of suitable processes is known to the person skilled in the art, as are process parameters from which suitable reaction conditions can be selected. Suitable processes are described, for example, in U.S. Pat. No. 4,483,819 and WO 98/37249.

After the reduction, deoxidation is preferably carried out. This can be effected, for example, by mixing the refractory metal powder with Mg, Ca, Ba, La, Y or Ce and then heating, or by heating the refractory metal in the presence of a getter in an atmosphere that allows oxygen to pass from the metal powder to the getter. The refractory metal powder is in most cases then freed of the salts of the deoxidising agent using an acid and water, and is dried.

It is advantageous if, when using metals to lower the oxygen content, the metallic impurities can be kept low.

A further process for preparing pure powder having a low oxygen content consists in reducing a refractory metal hydride using an alkaline earth metal as reducing agent, as disclosed, for example, in WO 01/12364 and EP-A-1200218.

The thickness of the coating is usually more than 0.01 mm. Preferred are layers with a thickness between 0.05 and 10 mm, more preferred between 0.05 and 5 mm, still more preferred between 0.05 and 1 mm, still more preferred between 0.05 and 0.5 mm.

The purities and oxygen and hydrogen contents of the resulting coatings should deviate not more than 50% and preferably not more than 20% from those of the powder.

Advantageously, this can be achieved by coating the substrate surface under an inert gas. Argon is advantageously used as the inert gas because, owing to its higher density than air, it tends to cover the object to be coated and to remain present, in particular when the surface to be coated is located in a vessel which prevents the argon from escaping or flowing away and more argon is continuously added.

The coatings applied according to the invention have a high purity and a low oxygen content and a low hydrogen content. Advantageously, these coatings have an oxygen content of less than 500, or less than 300, in particular an oxygen content of less than 100 ppm and a hydrogen content of less than 500, or less than 300, in particular an hydrogen content of less than 100 ppm.

In particular, these coatings have a purity of at least 99.7%, advantageously of at least 99.9%, in particular of at least 99.95%, and a content of less than 500 ppm oxygen, or less than 300 ppm oxygen, in particular an oxygen content of less than 100 ppm, and have a hydrogen content of less than 500, or less than 300, in particular a hydrogen content of less than 100 ppm.

In particular, these coatings have a purity of at least 99.95%, in particular of at least 99.995%, and a content of less than 500 ppm oxygen, or less than 300 ppm oxygen, in particular an oxygen content of less than 100 ppm and have a hydrogen content of less than 500, or less than 300, in particular a hydrogen content of less than 100 ppm.

In particular, these coatings have a purity of 99.999%, in particular of at least 99.9995%, and a content of less than 500 ppm oxygen, or less than 300 ppm oxygen, in particular an oxygen content of less than 100 ppm and have a hydrogen content of less than 500, or less than 300, in particular a hydrogen content of less than 100 ppm.

The coatings according to the invention have a total content of other non-metallic impurities, such as carbon, nitrogen or hydrogen, which is advantageously below 500 ppm and most preferably below 150 ppm.

The applied coating has a content of gaseous impurities which differs by not more than 50%, or not more than 20%, or not more than 10%, or not more than 5%, or not more than 1%, from the content of the starting powder with which this coating was produced. The term “differs” is to be understood as meaning in particular an increase; the resulting coatings should, therefore, advantageously have a content of gaseous impurities that is not more than 50% greater than the content of the starting powder.

The applied coating preferably has an oxygen content which differs by not more than 5%, in particular not more than 1%, from the oxygen content of the starting powder and has a hydrogen content which differs by not more than 5%, in particular not more than 1%, from the hydrogen content of the starting powder.

The coatings according to the invention preferably have a total content of other non-metallic impurities, such as carbon or nitrogen, which is advantageously less than 500 ppm and most preferably less than 150 ppm. With the process of this invention layers with higher impurity contents can also be produced.

In particular, the oxygen content is advantageously 50 ppm or less, the hydrogen content is advantageously 50 ppm or less, the nitrogen content is 25 ppm or less and the carbon content is 25 ppm or less.

The content of metallic impurities is advantageously 50 ppm or less, in particular 10 ppm or less.

In an advantageous embodiment, the coatings additionally have a density of at least 97%, preferably greater than 98%, in particular greater than 99% or 99.5%. 97% density of a layer means that the layer has a density of 97% of the bulk material. The density of the coating is here a measure of the closed nature and porosity of the coating. A closed, substantially pore-free coating always has a density of more than 99.5%. The density can be determined either by image analysis of a cross-sectional image (ground section) of such a coating, or alternatively by helium pycnometry. The latter method is less preferred because, in the case of very dense coatings, pores present in coatings that are more remote from the surface are not detected and a lower is porosity is accordingly measured than actually exists. By means of image analysis, the density can be determined by first determining the total area of the coating to be investigated in the image area of the microscope and relating this area to the areas of the pores. In this method, pores that are located far from the surface and close to the interface with the substrate are also detected. A high density of at least 97%, preferably greater than 98%, in particular greater than 99% or 99.5%, is important in many coating processes.

The coatings show high mechanical strength which is caused by their high density and by the high deformation of the particles. In the case of tantalum, therefore, the strengths are at least 80 MPa more preferably at least 100 MPa, most preferably at least 140 MPa when nitrogen is used as the gas with which the metal powder forms a gas-powder mixture. If helium is used, the strength usually is at least 150 MPa, preferably at least 170 MPa, most preferably at least 200 MPa and very most preferred greater than 250 MPa.

The articles to be coated with the process of this invention are not limited. Generally all articles which need a coating, preferably a corrosion protective coating, can be used. These articles may be made of metal and/or of ceramic material and/or of plastic material or may comprise components from these materials. Preferably surfaces of materials are coated which are subject to removal of material, for example by wear, corrosion, oxidation, etching, machining or other stress.

Preferably surfaces of materials are coated with the process of this invention which are used in corroding surroundings, for example in chemical processes in medical devices or in implants. Examples of apparatus or components to be coated are components used in chemical plants or in laboratories or in medical devices or as implants, such as reaction and mixing vessels, stirrers, blind flanges, thermowells, birsting disks, birsting disk holders, heat exchangers (shell and tubes), pipings, valves, valve bodies, sputter targets, X-ray anode plates, preferably X-ray rotating anodes, and pump parts.

The coatings prepared with the process of this invention preferably are used in corrosion protection.

The present invention therefore relates also to articles made of metal and/or of ceramic material and/or of plastic material containing at least one coatings composed of the metals niobium, tantalum, tungsten, molybdenum, titanium, zirconium, nickel, cobalt, iron, chromium, aluminium, silver, copper, or mixtures of two or more thereof or alloys of two or more thereof or alloys with other metals, which coatings have the above-mentioned properties.

Such coatings are in particular coatings of tantalum or niobium,

Preferably layers of tungsten, molybdenum, titanium zirconium or mixtures of two or more thereof or alloys of two or more thereof or alloys with other metals, very preferably layers of tantalum or niobium, are applied by cold spraying to the surface of a substrate to be coated. Surprisingly it has been found that with said powders or powder mixtures, preferably with tantalum and niobium powders, possessing a reduced oxygen content below 500 ppm and a reduced hydrogen content below 500 ppm, there can be produced cold sprayed layers with very high deposition rates of more than 90%. In said cold sprayed layers the oxygen content and the hydrogen content of the metal is nearly unchanged compared to the oxygen content and the hydrogen content of the powders. These cold sprayed layers show considerably higher densities than layers produced by plasma spraying or by vacuum spraying or than layers produced by cold spraying using metal powders with higher oxygen content and/or with higher hydrogen content as indicated above. Furthermore, these cold sprayed layers can be produced without any or with small texture, depending on powder properties and coating parameters. These cold sprayed layers are also object of this invention.

Suitable metal powders for use in the methods according to the invention are also metal powders that consist of alloys, pseudo alloys and powder mixtures of refractory metals with suitable non-refractory metals.

It is thereby possible to coat surfaces of substrates made of the same alloy or pseudo alloy.

These include especially alloys, pseudo alloys or powder mixtures of a metal selected from the group consisting of niobium, tantalum, tungsten, molybdenum, titanium, zirconium, nickel, cobalt, iron, chromium, aluminium, silver, copper, or mixtures of two or more thereof, with a metal selected from the group rhodium, palladium, platinum and gold. Such powders belong to the prior art, are known in principle to the person skilled in the art and are described, for example, in EP-A-774315 and EP-A-1138420.

They can be prepared by conventional processes; for example, powder mixtures are obtainable by homogenously mixing pre-prepared metal powders, it being possible for the mixing to be carried out on the one hand before use in the method according to the invention or alternatively during production of the gas-powder mixture. Alloy powders are in most cases obtainable by melting and mixing the alloying partners. According to the invention there may be used as alloy powders also so-called pre-alloyed powders. These are powders which are produced by mixing compounds such as, for example, salts, oxides and/or hydrides of the alloying partners and then reducing them, so that intimate mixtures of the metals in question are obtained. It is additionally possible according to the invention to use pseudo alloys. Pseudo alloys are understood as being materials which are obtained not by conventional melt metallurgy but, for example, by grinding, sintering or infiltration.

Known materials are, for example, tungsten/copper alloys or tungsten/copper mixtures, the properties of which are known and are listed here by way of example:

| | | | | Thermal | |
|---|---|---|---|---|---|
| | | | Electrical | expansion | Thermal |
| | Density | HB | conductivity | coefficient | conductivity |
| Type | (g/cm³) | (MPa) | (% IACS) | (ppm/K) | (W/m · K) |
| WCu10 | 16.8-17.2 | ≧2550 | >27 | 6.5 | 170-180 |
| WCu15 | 16.3 | | | 7.0 | 190-200 |
| WCu20 | 15.2-15.6 | ≧2160 | >34 | 8.3 | 200-220 |
| WCu25 | 14.5-15.0 | ≧1940 | >38 | 9.0 | 220-250 |
| WCu30 | 13.8-14.4 | ≧1720 | >42 | | |

Also known are molybdenum-copper alloys or molybdenium/copper mixtures in the same ratios as indicated above.

Also known are molybdenum-silver alloys or molybdenium/silver mixtures which contain, for example, 10, 40 or 65 wt. % molybdenum.

Also known are tungsten-silver alloys or tungsten/silver mixtures which contain, for example, 10, 40 or 65 wt. % tungsten.

Also known are nickel-chromium alloys or nickel-chromium mixtures which contain, for example, 80 wt. % nickel.

These can be used, for example, in heat pipes, cooling bodies or, in general, in temperature management systems.

It is also possible to use tungsten-rhenium alloys or mixtures, or the metal powder is an alloy having the following composition:

from 94 to 99 wt. %, preferably from 95 to 97 wt. %, molybdenum, from 1 to 6 wt. %, preferably from 2 to 4 wt. %, niobium, from 0.05 to 1 wt. %, preferably from 0.05 to 0.02 wt. %, zirconium.

These alloys, like pure metal powders having a purity of at least 99.95%, can be used in the recycling or production of sputter targets by means of cold gas spraying.

The following figures illustrate the invention.

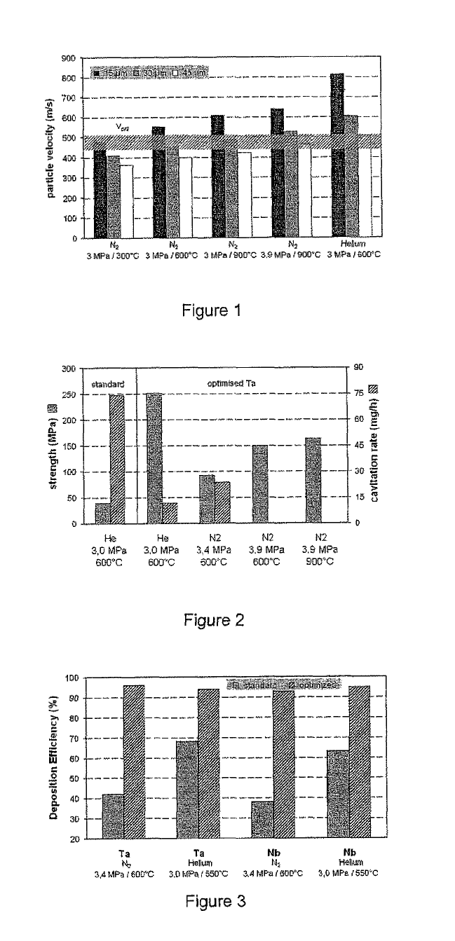

FIG. 1 illustrates the velocity of Ta particles sprayed using different gases and parameters.

FIG. 2 illustrates TCT strength and cavitation rate of Ta coatings.

FIG. 3 illustrates deposition efficiency of Ta and Nb powders.

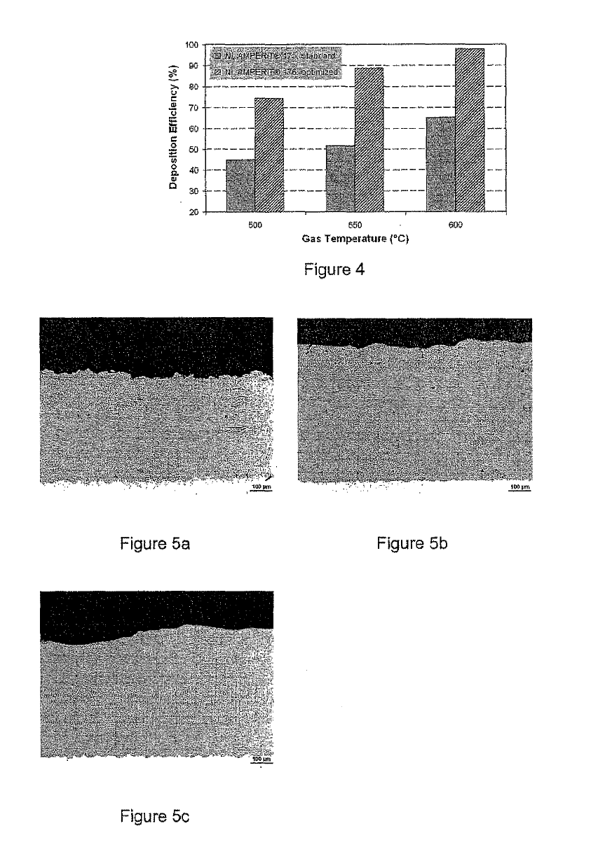

FIG. 4 illustrates the deposition efficiency of Ni at different temperatures using N₂ and a pressure of 3.3 MPa

FIG. 5 illustrates light microscope pictures of unetched Ta coatings. In FIG. 5a coatings made from Ta, AMPERIT® 150, standard using helium is shown; in FIG. 5b coatings made from Ta, AMPERTIT® 151, optimised using nitrogen is shown; and in FIG. 5c coatings made from Ta, AMPERIT® 151, optimised using helium is shown.

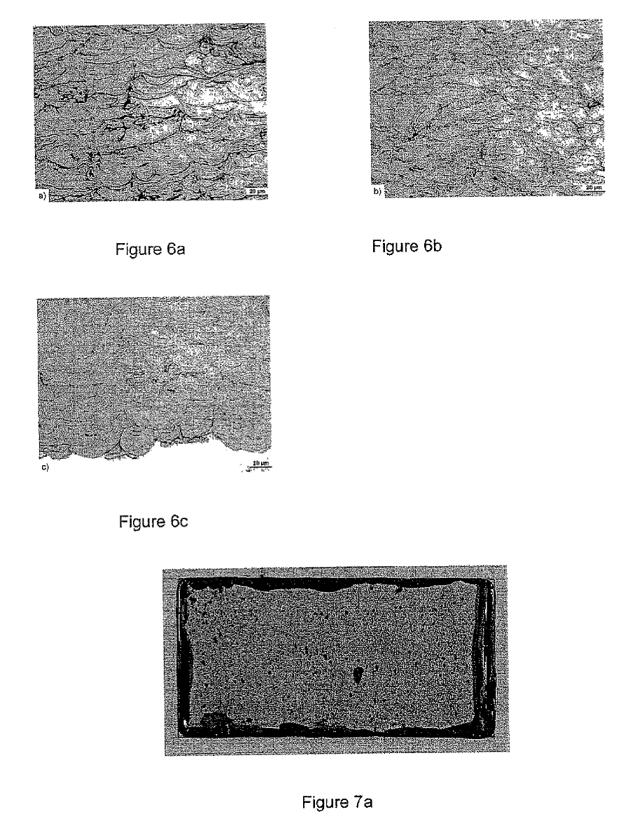

FIG. 6 illustrates light microscope pictures of the Ta coatings of FIG. 5 that have been etched. The coatings of FIGS. 6a, 6b and 6c correspond to the coatings of FIGS. 5a, 5b and 5c.

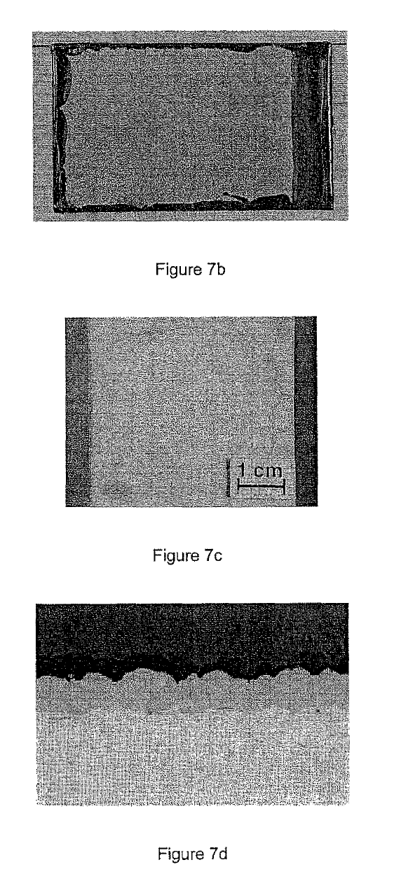

FIG. 7 illustrates Ta coatings sprayed on mild steel after corrosion testing. In FIG. 7a a coating after salt spray test: Ta, standard, He, after 168 h is shown; in FIG. 7b a coating after salt spray test: Ta, optimised, N₂ after 1008 h is shown; in FIG. 7c the surface of a coating after an emerging test (28 days, 20% HCl, 70° C.): Ta, optimised, N₂ is shown; and in FIG. 7d the cross section of the coating of FIG. 7c is shown within the test area.

In the following table the powders used in the Examples are characterised.

| | Ta | Ta | Nb | Ni | Ni |
|---|---|---|---|---|---|
| | Standard | optimised | optimised | standard | optimised |
| AMPERIT ® | 150 | 151 | 161 | 175 | 176 |
| | fused | fused | fused | Water | Gas |
| | | | | atomised | atomised |
| Grain size (μm) | 45/15, 38/10, | 30/10 | 30/10 | 45/15, 25/5 | 30/10 μm |
| | 25/5 | | | | |
| Purity | min. 99.9 | min. 99.95 | min. 99.9 | min. 99.9 | min. 99.9 |
| Oxygen (ppm) | 1300-1600 | <300 | <800 | ~1800 | <300 |
| Hydrogen (ppm) | <100 | <50 | <50 | — | — |

### EXAMPLES

### Production of Coatings

Tantalum and niobium coatings were produced. The metal powders used are indicated in the table above. These powders are commercially available from H.C. Starok GmbH & Co.KG in Goslar.

Very strong and dense coatings were obtained, which exhibited low porosity and excellent adhesion to the substrates in question. The flow rate densities were between 11 and 21 g/sec*cm².

The results of the experiments is shown in the Figures.

The system was operated at gas supply pressures up to 3.4 MPa and gas temperatures of up to 600° C. Nitrogen and helium were used as process gases. At these conditions the gas flows were about 80 ml/h for N₂ and 190 m³/h for He. Due to its lower density significantly higher gas and particle velocities can be achieved using helium (FIG. 1). The gas pressure must be set to at least 3 MPa and the gas temperature to 600° C. In addition the powder particles were heated in a pre-chamber almost up to gas temperature. In many cases this preheating can enhance the ductility of hard and high melting crucially.

A considerable increase in the deposition efficiency was observed when the optimised Ta powder with much lower oxygen contents of about 250 ppm and low hydrogen contents of less than 50 ppm was used. With both nitrogen and helium deposition efficiency values of above 90% were achieved.

The corrosion behaviour of the coatings sprayed using both gases He and N₂ turned out to be comparable. With both gases completely dense coatings providing an effective corrosion protection can be produced. After 1000 h in the salt spray test as well as after 28 days exposed to 20% HCl solution at 70° C. even a 90 μm thin Ta coating does not show any indication of corrosion of the mild steel substrate. In the hydrochloric acid even the degradation rate of the Ta coating was below the detection limit of 0.01 mm/a.

The same optimisation measures were performed for Nb which is very similar to Ta in terms of its chemical and metallurgical properties. The oxygen content was significantly reduced and the grains size distribution was adjusted. The spray tests show that with the optimised niobium powder AMPERIT® 161 very dense coatings can also be generated. The spray particles exhibit a high degree of deformation as well as a good bonding. Also the deposition efficiency could be increased from 60 to over 90% by these optimisations.

With Ni as an example it is shown that very similar modifications can be successfully performed for non refractory metals, too. Generally Ni powders for thermal spraying are produced by water atomising resulting in a partially irregular morphology of such a powder. Due to the manufacturing process water atomised Ni powders contain a high oxygen content of about 0.18 wt. %. The optimised powder has been produced by gas atomisation and contains only 180 ppm oxygen, which is only 10% compared to the water atomised powder. In addition, the powder particles are predominantly spherical. The spray tests illustrate that for both powders the deposition efficiency raises when the gas temperature is increased. However, the deposition efficiency is about 20% higher when the optimised Ni powder AMPERIT® 176 is used and reaches values of over 90% at 600° C. The coatings sprayed from this optimised powder exhibit a higher density and the particles show higher deformation as well as better bonding to each other.

1-30. (canceled)

31. A method of applying coatings to surface of an object which comprises forming with a gas-powder mixture with a powder of a material selected from the group consisting of niobium, tantalum, tungsten, molybdenum, titanium, zirconium, nickel, cobalt, iron, chromium, aluminum, silver, copper, mixtures of at least two thereof and their alloys with at least two thereof or with other metals, the powder has a particle size of from 0.5 to 150 μm, an oxygen content of less than 500 ppm oxygen and a hydrogen content of less than 500 ppm, wherein a supersonic speed is imparted to the gas flow and spraying the jet of supersonic speed onto the surface of an object.

32. The method as claimed in claim 31, wherein the powder is added to the gas in an amount such that a flow rate density of the particles of from 0.01 to 200 g/s cm².

33. The method as claimed in claim 31, wherein the powder is added to the gas in an amount such that a flow rate density of the particles of from 0.05 g/s cm² to 17 g/s cm².

34. The method as claimed in claim 31, wherein the spraying comprises the steps of:
providing a spraying orifice adjacent a surface to be coated by spraying;
providing to the spraying orifice a powder of a particulate material selected from the group consisting of niobium, tantalum, tungsten, molybdenum, titanium, zirconium, nickel, cobalt, iron, chromium, aluminum, silver, copper, mixtures of at least two thereof or alloys thereof with one another or other metals, the powder having a particle size of 0.5 to 150 μm, an oxygen content of less than 500 ppm oxygen and a hydrogen content of less than 500 ppm, said powder being under pressure;
providing an inert gas under pressure to the spraying orifice to establish a static pressure at the spraying orifice and providing a spray of said particulate material and gas onto the surface to be coated; and
locating the spraying orifice in a region of low ambient pressure which is less than 1 atmosphere and which is substantially less than the static pressure at the spraying orifice to provide substantial acceleration of the spray of said particulate material and gas onto said surface to be coated.

35. The method as claimed in claim 31, wherein the spraying is performed with a cold spray gun and the target to be coated and the cold spray gun is located within a vacuum chamber at pressures below 80 kPa.

36. The method as claimed in claim 31, wherein the speed of the powder in the gas-powder mixture is from 300 to 2000 m/s.

37. The method as claimed in claim 35, wherein the speed of the powder in the gas-powder mixture is from 300 to 1200 m/s and the pressures are between 2 and 10 kPa.

38. The method as claimed in claim 31, wherein the powder particles striking the surface of the object form a coating.

39. The method as claimed in claim 38, wherein the applied coating has a particle size of from 10 to 50 μm.

40. The method as claimed in claim 31, wherein the metal powder has gaseous impurities of from 10 to 1000 ppm, based on the weight.

41. The method as claimed in claim 31, wherein the metal powder has an oxygen content of less than 300.

42. The method as claimed in claim 31, wherein the metal powder has a hydrogen content of less than 300.

43. The method as claimed in claim 31, wherein the metal powder has a hydrogen content of less than 100 ppm and an oxygen content of less than 100 ppm.

44. The method as claimed in claim 31, wherein the applied coating has an oxygen content of less than 500 ppm and a hydrogen content of less than 500 ppm.

45. The method as claimed in claim 31, wherein the applied coating has an oxygen content of less than 100 ppm and a hydrogen content of less than 100 ppm.

46. The method as claimed in claim 31, wherein the applied coating has a content of gaseous impurities which differs by not more than 50% from the content of the starting powder.

47. The method as claimed in claim 31, wherein the applied coating has a content of gaseous impurities which differs by not more than 20%, from the content of the starting powder.

48. The method as claimed in claim 31, wherein the applied coating has a content of gaseous impurities which differs by not more than 1%, from the content of the starting powder.

49. The method as claimed in claim 31, wherein the applied coating has an oxygen content and a hydrogen content which differ by not more than 5%, from the oxygen content and the hydrogen content of the starting powder.

50. The method as claimed in claim 31, wherein the applied coating has an oxygen content and a hydrogen content which differ by not more than 1%, from the oxygen content and the hydrogen content of the starting powder.

51. The method as claimed in claim 31, wherein the oxygen content of the applied coating is not more than 300 ppm and wherein the hydrogen content of the applied coating is not more than 300 ppm.

52. The method as claimed claim 39, wherein the applied metal coating consists of tantalum, niobium or nickel.

53. The method as claimed in claim 31, wherein the thickness of the coating is from 10 μm to 10 mm.

54. The method as claimed in claim 31, wherein the thickness of the coating is from 50 μm to 5 mm.

55. The method as claimed in claim 31, wherein layers are applied by cold spraying to the surface of an object to be coated, preferably layers of tantalum or niobium.

56. The method as claimed in claim 31, wherein the metal powder is an alloy having the following composition: from 94 to 99 wt. % molybdenum, from 1 to 6 wt. % niobium, from 0.05 to 1 wt. % zirconium.

57. The method as claimed in claim 31, wherein the metal powder is an alloy having the following composition: from 95 to 97 wt. % molybdenum, from 2 to 4 wt. % niobium, from 0.05 to 0.02 wt. %, zirconium.

58. The method as claimed in claim 31, wherein the metal powder is an alloy, pseudo alloy or powder mixture of a refractory metal selected from the group consisting of niobium, tantalum, tungsten, molybdenum, titanium and zirconium with a metal selected from the group cobalt, nickel, rhodium, palladium, platinum, copper, silver and gold.

59. The method as claimed in claim 31, wherein the metal powder consists of a tungsten-rhenium alloy.

60. The method as claimed in claim 31, wherein the metal powder consists of a mixture of a titanium powder with a tungsten powder or a molybdenum powder.

61. A corrosion resistant metal protection coating on a shaped object obtained by the method as claimed in claim 31.

62. A cold sprayed layer of tungsten, molybdenum, titanium zirconium, nickel, cobalt, iron, chromium, aluminium, silver, copper, mixtures of two or more thereof or of alloys of two or more thereof or of alloys with other metals possessing an oxygen content below 500 ppm and a hydrogen content below 500 ppm.

63. The cold sprayed layer as claimed in claim 62, wherein the layer is made of tantalum, niobium or nickel.

64. A coated object comprising at least one layer of the metals niobium, tantalum, tungsten, molybdenum, titanium, zirconium, nickel, cobalt, iron, chromium, aluminium, silver, copper, mixtures of two or more thereof or alloys of two or more thereof or alloys with other metals which is obtained by the process of claim 31.

65. The coated object as claimed in claim 64, wherein the coated object is made of metal and/or of ceramic material and/or of plastic material or comprises components from at least one of these materials.

66. The coated object as claimed in claim 64, wherein the coated object is a component used in chemical plants or in laboratories or in medical devices or as implants, a stirrer, a blind flange, a thermowell, a birsting disk, a birsting disk holder, a heat exchanger (shell and/or tube), a piping, a valve, a valve body, a sputter target, a X-ray anode plate, or a pump part.
